(19) United States
(12) Patent Application Publication
(10) Pub. No.: US 2015/0213570 A1
(43) Pub. Date: Jul. 30, 2015

(54) METADATA TREE OF A PATIENT WITH LOCKBOXES

(71) Applicant: HEWLETT-PACKARD DEVELOPMENT COMPANY, LP, Houston, TX (US)

(72) Inventors: Jun Li, Palo Alto, CA (US); Ram Swaminathan, Palo Alto, CA (US); Sharad Singhal, Palo Alto, CA (US)

(21) Appl. No.: 14/421,784

(22) PCT Filed: Sep. 19, 2012
(86) PCT No.: PCT/US12/56142

§ 371 Date: Feb. 13, 2015

Related U.S. Application Data
(60) Provisional application No. 61/683,708, filed on Aug. 15, 2012.

(51) Int. Cl. G06Q 50/22; G06F 21/62; G06F 17/30; G06F 19/00

(52) U.S. Cl. CPC G06Q 50/22; G06F 19/322; G06F 21/6245; G06F 17/30342; G06Q 2220/10

(57) ABSTRACT

A method performed by a processing system includes encrypting an electronic health record of a patient using a record key, encrypting a portion of a node of a metadata tree of the patient with a node key, the portion including a reference to the encrypted record in an encrypted data store, and updating the metadata tree for the patient to include the encrypted node and a node key lockbox with the node key.

### CROSS REFERENCE TO RELATED APPLICATION

This application claims priority to U.S. Provisional Patent Application No. 61/683,708, entitled “Hierarchical Lockboxes to Enable Sharing of Metadata and Data Records in the Cloud-Based EHR Store”, and filed Aug. 15, 2012. The disclosure of this application is incorporated by reference herein.

### BACKGROUND

Electronic Health Records (EHRs) may enable healthcare participants (e.g., patients, healthcare providers, payers, and researchers) to improve coordination of care and access to health information. Although EHRs may facilitate access to healthcare information, the sharing of healthcare information may involve many complex technical and legal issues. These issues may be burdensome for healthcare participants that lack the resources and expertise to enable such sharing while ensuring consistency, privacy, and security of the healthcare information.

### BRIEF DESCRIPTION OF THE DRAWINGS

FIG. 1 is a block diagram illustrating one example of an electronic health record store processing environment with hierarchical lockboxes in metadata trees.

FIG. 2 is a block diagram illustrating one example of a metadata tree with hierarchical lockboxes and an encrypted data store.

FIG. 3 is a block diagram illustrating one example of a metadata tree node.

FIG. 4 is a block diagram illustrating one example of a participant system.

FIG. 5 is a schematic diagram illustrating one example of storing an encrypted record using a metadata tree with hierarchical lockboxes.

FIG. 6 is a schematic diagram illustrating one example of accessing an encrypted record using a metadata tree with hierarchical lockboxes.

FIG. 7 is a schematic diagram illustrating one example of performing a key revocation using a metadata tree with hierarchical lockboxes.

FIG. 8 is a block diagram illustrating one example of key revocation using a metadata tree with hierarchical lockboxes.

FIG. 9 is a block diagram illustrating one example of key revocation and key propagation using a metadata tree with hierarchical lockboxes.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

Embodiments described herein provide an electronic health record (EHR) store processing environment that enables secure, seamless sharing of EHRs among healthcare participants (e.g., patients, healthcare providers, payers, and researchers). The environment includes an encrypted data store that stores encrypted EHRs of patients and a metadata store that stores a metadata tree for each patient. Each metadata tree provides a mapping to the EHRs of a given patient in the encrypted data store. The metadata tree for each patient may be accessed by authorized healthcare participants, such as healthcare providers, to allow the participants to access and store EHRs of patients.

The environment controls access to EHRs using record keys for encrypted EHRs and node keys for the nodes of metadata trees. Healthcare participants that store encrypted EHRs in the encrypted data store encrypt the EHRs using record keys. These participants also add encrypted nodes for the corresponding encrypted EHRs to the metadata tree. The encrypted nodes include references to the corresponding encrypted EHRs and are encrypted with corresponding node keys.

Each metadata tree also includes separate hierarchical lockbox mechanisms for storing the node keys and the record keys. In particular, each node in the metadata tree includes a node key lockbox (i.e., a first hierarchical lockbox mechanism) to store a corresponding set of node keys and a record key lockbox to store a corresponding record key. Each node key is usable, prior to being revoked, to encrypt and decrypt the corresponding node and to lock and unlock the node key lockbox at each node under the corresponding node. Each record key is usable either to lock and unlock the record key lockbox at each node (i.e., a second hierarchical lockbox mechanism) under the corresponding node or to encrypt and decrypt a corresponding EHR. The separate hierarchical lockbox mechanisms allow access rights to be granted separately for metadata tree nodes and encrypted EHRs.

One or more healthcare participants may manage different subtrees of the metadata tree of a patient. A healthcare participant that manages a subtree maintains node and record keys for a top-most node in the subtree, where the node and record keys are derived from a patient key of the patient. Because the node and record keys for each subtree are derived from the patient key, a patient can unlock the node and record lockboxes at all levels of each subtree to obtain access to all of the patient's EHRs.

To manage a subtree, a participant manages the node and the record keys of the corresponding nodes in the subtree to grant and revoke access to other authorized healthcare participants of a patient. A participant grants access by providing selected node and record keys to another participant. Because node and record keys at a given node of a subtree may be used to unlock corresponding lockboxes at all nodes under the given node, the participant controls the level of access by selecting which node and record keys to share.

A participant revokes access by rotating the node key in the node key lockbox at a revoked node in the subtree. After a key revocation, a participant whose access has been revoked will continue to be able to unlock node key lockboxes corresponding to encrypted nodes that are stored under the revoked node prior the revocation. Thus, the revoked participant will continue to be able to access encrypted EHRs that were stored prior to the revocation. The revoked participant will not, however, be able to unlock node key lockboxes corresponding to encrypted nodes that are stored under the revoked node after the revocation. In particular, the revoked participant will not be able to unlock the node keys for these nodes which are needed to decrypt the references to corresponding encrypted EHRs (i.e., the encrypted EHRs that are stored after the revocation). The revoked participant will also not be able to add new encrypted nodes under the revoked node.

As used herein, the term “healthcare participant” (also referred to as “participant”) refers to a patient, a healthcare provider, a payer, a researcher, or other suitable person involved in a healthcare process of a patient that generates and/or uses healthcare information corresponding to a patient. The term “patient” refers to a person that receives at least one healthcare service from a healthcare provider. The term “healthcare provider” (also referred to as “provider”) refers to a person and/or institution that provide(s) at least one healthcare service to a patient.

The term “electronic health record” (EHR) refers to a set of healthcare information generated by a healthcare participant and stored in an electronic format on at least one machine-readable storage medium. The term “encrypted electronic health record” refers to an electronic health record that has been encrypted with an encryption key such as a record key.

The term “metadata” refers to a set of information that describes at least one record, such as an electronic health record. The term “metadata tree” refers to a set of nodes that include metadata where each node has a specified relationship with at least one other node in the set.

The term “record key” refers to an encryption key that is used to encrypt and decrypt an EHR of a patient. The term “node key” refers to an encryption key that is used to encrypt and decrypt at least a portion of a node in a metadata tree of a patient. The term “metadata tree key” refers to an encryption key that is used to encrypt and decrypt at least a portion of a metadata tree of a patient.

The term “record key lockbox” refers to a data structure that stores a record key corresponding to a node in a metadata tree and may be locked and unlocked only with a corresponding record key from a parent node of the node in the metadata tree. The term “node key lockbox” refers to a data structure that stores a set of one or more node keys corresponding to a node in a metadata tree and may be locked and unlocked only with a corresponding set of one or more node keys from a parent node of the node in the metadata tree.

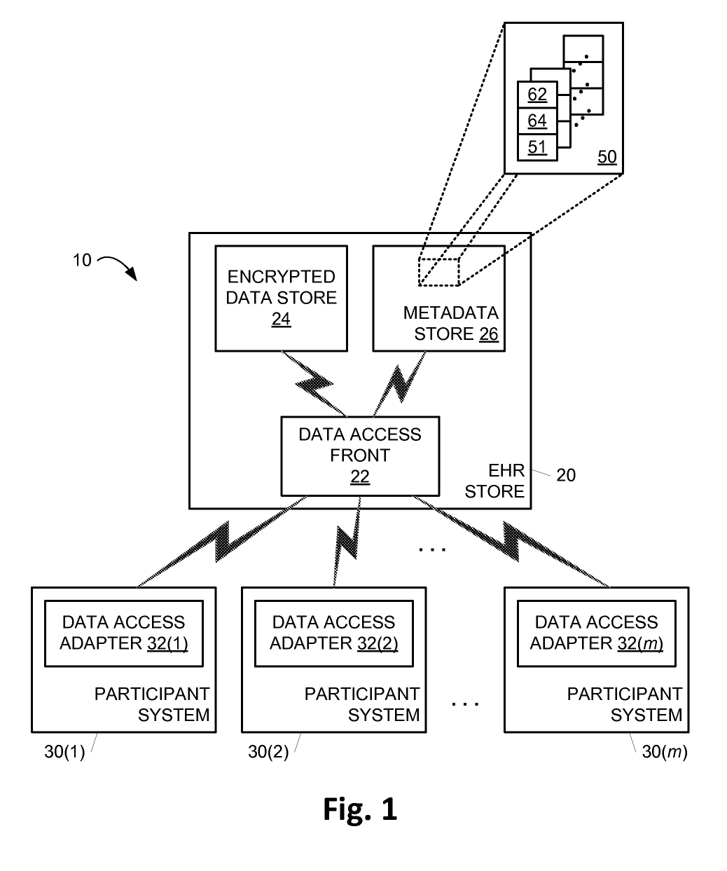

FIG. 1 is a block diagram illustrating one example of an electronic health record store processing environment 10 with hierarchical lockboxes 62 and 64 in each metadata tree 50. Environment 10 includes electronic health record (EHR) store 20 and a set of healthcare participant systems 30(1)-30(m) where m is an integer that is greater than or equal to two. Environment 10 provides the ability to create, access, store, manage, and share EHRs of patients using EHR store 20 and participant systems 30.

EHR store 20 includes a data access front 22, an encrypted data store 24, and a metadata store 26. Data access front 22 communicates with participant systems 30 to manage accesses to encrypted data store 24 and metadata store 26 by participant systems 30.

Encrypted data store 24 stores encrypted EHRs of patients that were generated and provided by participant systems 30. The encrypted EHRs are encrypted and decrypted by participant systems 30 using corresponding record keys. Encrypted data store 24 includes any suitable type, number, and/or configuration of machine-readable storage media to store the encrypted EHRs. Because the EHRs are encrypted and because encrypted data store 24 does not store the encryption keys (i.e., record keys) for the EHRs, encrypted data store 24 may or may not be a trusted data store (e.g., encrypted data store 24 may be owned or operated by one or more untrusted third parties).

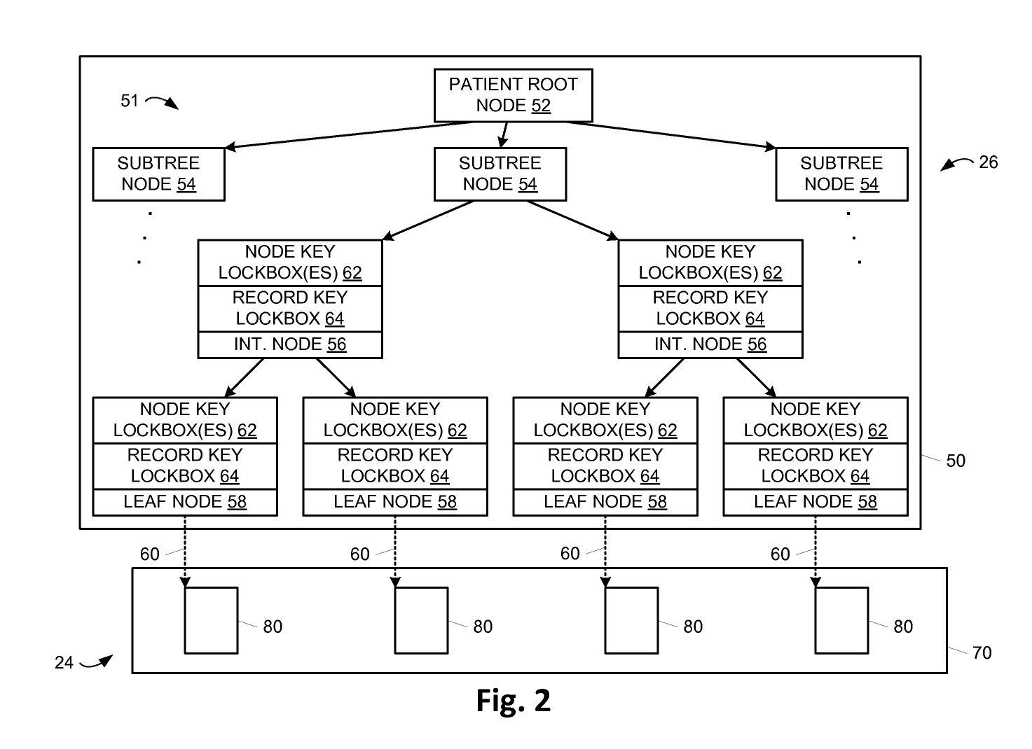

Metadata store 26 stores a metadata tree 50 for each patient where each metadata tree 50 includes a set of nodes 51 with corresponding node key lockboxes 62 and record key lockboxes 64. Nodes 51 are arranged in a hierarchical tree structure and, as shown in the example of FIG. 2, include a patient root node 52, any suitable number of subtree nodes 54, any suitable number and suitable number of levels of intermediate nodes 56, and a leaf node 58 for each corresponding encrypted EHR 80.

Patient root node 52 includes information that identifies the patient. Subtree nodes 54 identify corresponding healthcare participants that manage the corresponding subtrees formed by the collection of nodes 56 and 58 under each subtree node 54. Intermediate nodes 56 represent logical groupings of EHRs (e.g., by categories of patient information such as treatment conditions) and include information that describes the groupings. Each leaf node 58 stores metadata that describes a corresponding encrypted EHR 80, where the metadata includes a reference 60 to the encrypted EHR 80 in encrypted data store 24 as indicated by the dotted arrows representing references 60 in FIG. 2. References 60 may be used to access encrypted EHRs 80 in encrypted data store 24.

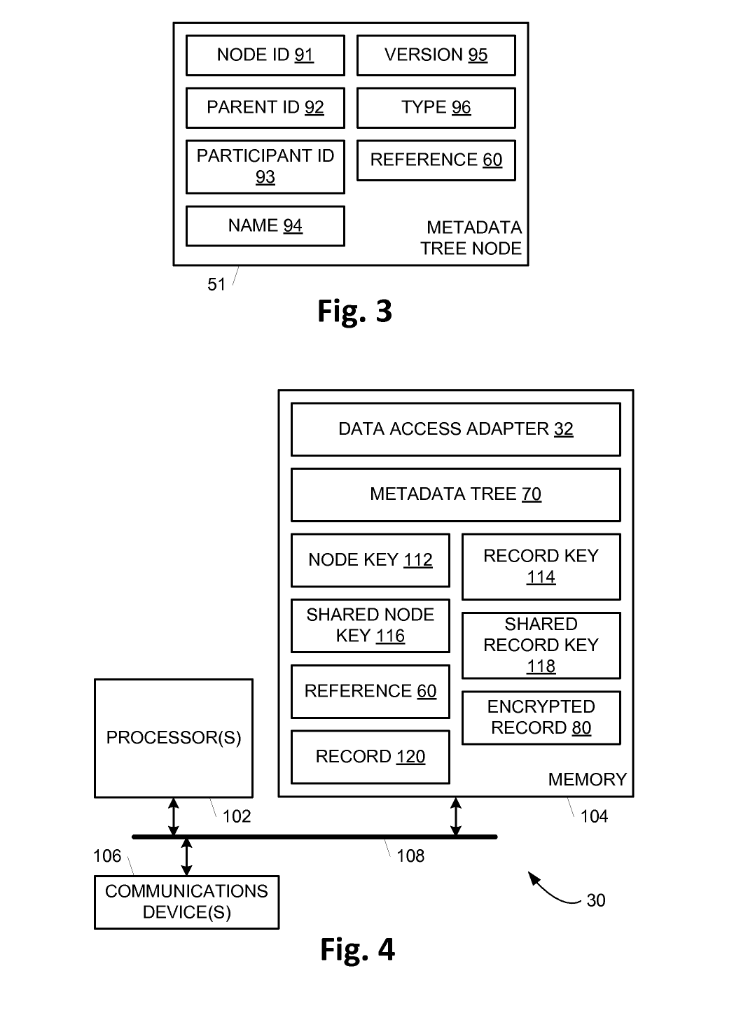

FIG. 3 is a block diagram illustrating one example of a metadata tree node 51. Metadata tree node 51 includes a node identifier 91, a parent identifier 92, a participant identifier 93, a name 94, a version 95, a type 96, and a reference 60. Node identifier 91 is a globally unique identifier for node 51, and parent identifier 92 is a node identifier 91 of a parent node of node 51. Participant identifier 93 is information that identifies the healthcare participant that created node 51. Name 94 is a name given by the healthcare participant that created node 51. Version 95 is a version number of node 51. Type 96 is a type of node 51. Reference 60 identifies a location of an encrypted EHR 80 in encrypted data store 24.

Referring back to FIG. 2, each node 51 is encrypted by a participant system 30 using a corresponding node key, and the node key and any revoked node keys (described below) are stored in a node key lockbox 62 corresponding to a node 51. A record key lockbox 64 corresponding to a node 51 stores the record key for a corresponding EHR 80 in encrypted data store 24. In order to access an encrypted EHR 80 from encrypted data store 24, a participant system 30 needs the reference 60 to locate the encrypted EHR 80 in encrypted data store 24 and the record key to decrypt the encrypted EHR 80.

The collection of node and record key lockboxes 62 and 64 in each metadata tree 50 forms separate hierarchical lockbox mechanisms for storing node keys and record keys, respectively. The separate hierarchical lockbox mechanisms allow access rights to be granted separately for metadata tree nodes 51 and encrypted EHRs 80.

Each node key lockbox 62 stores a set of node keys (i.e., a current node key and any revoked node keys) for a corresponding node 51. Each node key is usable to encrypt and decrypt the corresponding node 51 and, prior to being revoked, to lock and unlock each node key lockbox 62 at each node 51 under the corresponding node 51. For example, a node key from a node key lockbox 62 in an intermediate node 56 may be used to lock and unlock each node key lockbox 62 of each leaf node 58 directly under the intermediate node 56 as well as any other node key lockboxes 62 of other intermediate nodes 56 directly under the intermediate node 56 (not shown in FIG. 2).

Each record key lockbox 64 stores a record key for a corresponding node 51. Each record key is usable either to lock and unlock the record key lockbox at each encrypted node under the encrypted node or to encrypt and decrypt a corresponding encrypted EHR 80. For example, a record key from a record key lockbox 64 in an intermediate node 56 may be used to lock and unlock each record key lockbox 64 of each leaf node 58 directly under the intermediate node 56 as well as any other record key lockboxes 64 of other intermediate nodes 56 directly under the intermediate node 56 (not shown in FIG. 2). Record keys from each leaf node 58 may be used to encrypt and decrypt a corresponding encrypted EHR 80.

Metadata tree 50 allows unaffiliated healthcare participants (e.g., providers practicing under different, unrelated business entities) to store different encrypted EHRs 80 of a patient to encrypted data store 24 and share those encrypted EHRs 80 with other healthcare participants. Encrypted EHRs 80 are each encrypted with different record keys such that a record key for one encrypted EHR 80 may not be used to decrypt any other encrypted EHR 80. Healthcare participants may use metadata tree 50 to determine which encrypted EHRs 80 they need to access and can request access (i.e., node and record keys) from other healthcare participants that generated the needed encrypted EHRs 80 or the patient.

Participants, including patients, healthcare providers, payers, researchers, and other suitable persons involved in healthcare processes of patients, (not shown) interact with corresponding participant systems 30 to communicate with EHR store 20 using corresponding data access adapters 32 to create, access, store, manage, and share EHRs 80 of patients. Each data access adapter 32 communicates with data access front 22 on EHR store 20 to access encrypted data store 24 and metadata store 26.

One or more healthcare participants may manage different subtrees that stem from each subtree node 54 of metadata tree 50. A healthcare participant that manages a subtree maintains subtree node and subtree record keys for a subtree node 54 (i.e., a top-most node in the subtree), and the subtree node and subtree record keys are derived from a patient key of the patient (e.g. provided to a healthcare participant when a patient registers with the participant). In the example of FIG. 2, the subtree node and subtree record keys for subtree nodes 54 are stored only on healthcare participant systems 30 (i.e., not in lockboxes 62 and 64 corresponding to subtree nodes 54). In other examples not shown, the subtree node and subtree record keys for subtree nodes 54 may be stored in lockboxes 62 and 64 corresponding to subtree nodes 54 in metadata tree 50 in addition to being stored on healthcare participant systems 30.

Participants manage subtrees of metadata tree 50 using participant systems 30. To do so, participant systems 30 manage the node and the record keys of the corresponding nodes 54, 56, and 58 in the subtree to grant and revoke access to other authorized healthcare participants of a patient using other participant systems 30. A participant system 30 grants access by providing selected node and record keys to another participant system 30. Because node and record keys at a given node 54, 56, or 58 of a subtree may be used to unlock corresponding lockboxes at all nodes 56 and/or 58 under the given node 54, 56, or 58, the participant system 30 controls the level of access by selecting which node and record keys to share with the other participant system 30.

In environment 10, EHR store 20 and participant systems 30 may be implemented with any suitable type, number, and configuration of processing systems that each include one or more processors for executing instructions stored in one or more memories (i.e., computer-readable media). In particular, data access front 22, encrypted data store 24, and metadata store 26 may be implemented using different processing systems in some embodiments. An example of participant system 30 is shown in FIG. 4 and described in additional detail below. In addition, any suitable type, number, and configuration of wired and/or wireless network devices (not shown) may be used to allow the processing systems to communicate.

FIG. 4 is a block diagram illustrating one example of a participant system 30. Participant system 30 includes a set of one or more processors 102 configured to execute a set of instructions stored in a memory system 104, memory system 104, and at least one communications device 106. Processors 102, memory system 104, and communications devices 106 communicate using a set of interconnections 108 that includes any suitable type, number, and/or configuration of controllers, buses, interfaces, and/or other wired or wireless connections.

Participant system 30 represents any suitable processing device or portion of a processing device such as a server computer, a laptop computer, a tablet computer, a desktop computer, a mobile telephone with processing capabilities (i.e., a smart phone), or another suitable type of electronic device with processing capabilities. Each processor 102 is configured to access and execute instructions stored in memory system 104 and to access and store data in memory system 104. Memory system 104 includes any suitable type, number, and configuration of volatile or non-volatile machine-readable storage media configured to store instructions and data. Examples of machine-readable storage media in memory system 104 include hard disk drives, random access memory (RAM), read only memory (ROM), flash memory drives and cards, and other suitable types of magnetic and/or optical disks. The machine-readable storage media are considered to be part of an article or article of manufacture. An article or article of manufacture refers to one or more manufactured components. Communications devices 106 include any suitable type, number, and/or configuration of communications devices configured to allow participant system 30 to communicate across one or more wired or wireless networks.

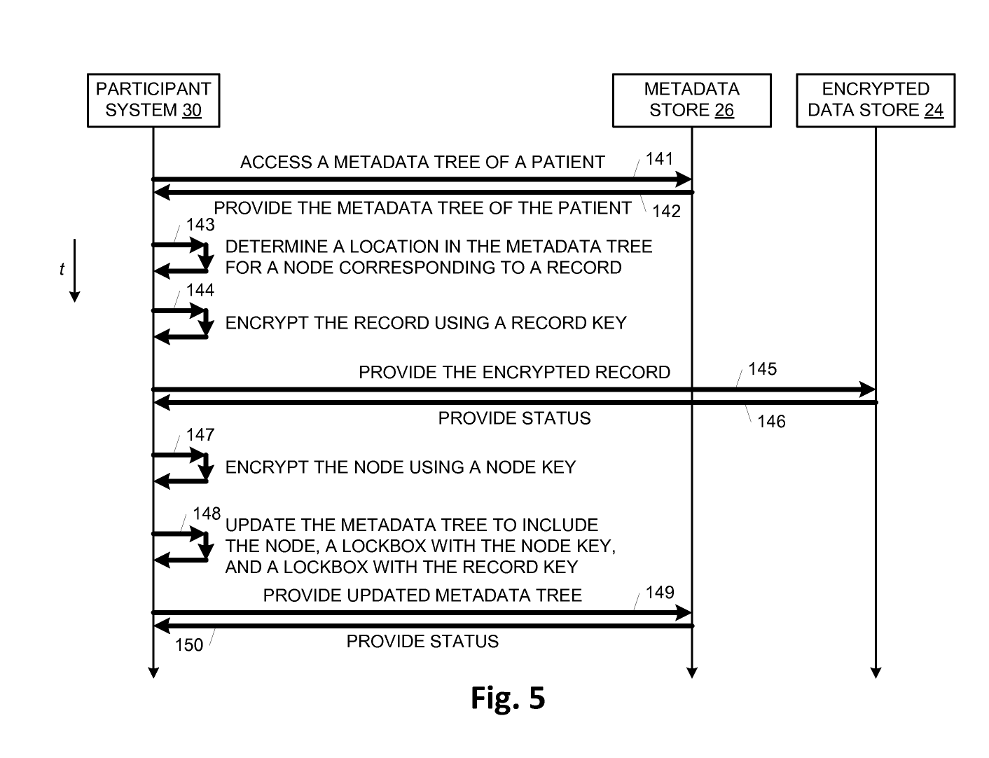

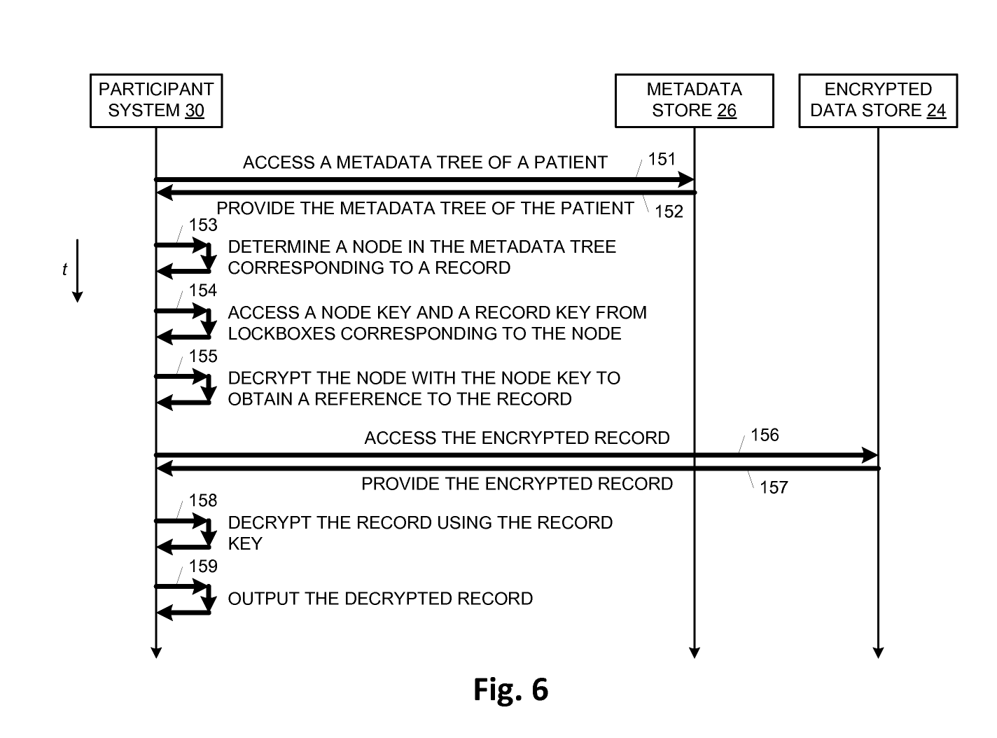

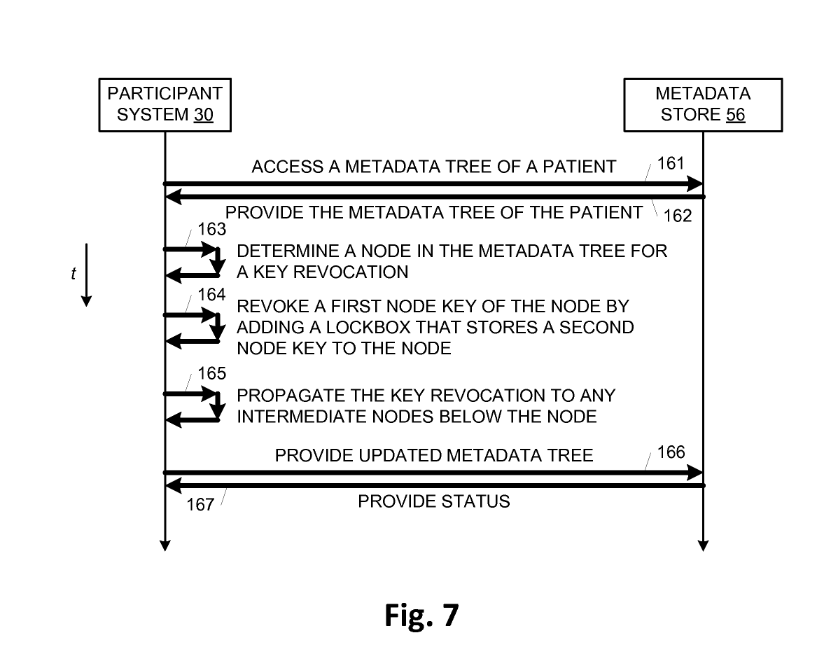

Data access adapter 32 includes instructions that, when executed by processors 102, causes processors 102 to perform the functions of data access adapter 32 that will now be described with reference to FIGS. 5, 6, and 7. FIG. 5 is a schematic diagram illustrating one example of storing an encrypted record 80 using metadata tree 50 with hierarchical lockboxes 62 and 64. FIG. 6 is a schematic diagram illustrating one example of accessing an encrypted record 80 using metadata tree 50 with hierarchical lockboxes 62 and 64. FIG. 7 is a schematic diagram illustrating one example of performing a key revocation using a metadata tree with hierarchical lockboxes.

Referring to FIGS. 4 and 5, data access adapter 32 accesses metadata tree 50 of a patient from metadata store 26 through data access front 22 as indicated by an arrow 141. Metadata store 26 provides metadata tree 50 to provider system 30 through data access front 22 as indicated by an arrow 142. Data access adapter 32 determines a location in metadata tree 50 for a leaf node 58 corresponding to a new or updated EHR 120 as indicated by an arrow 143. Based on the location, data access adapter 32 either generates a node key 112 using another node key in the subtree above the location in metadata tree 50 or receives node key 112 from another participant system 30 that manages the subtree. Data access adapter 32 also either generates a record key 114 using another record key in the subtree above the location in metadata tree 50 or receives record key 114 from another participant system 30 that manages the subtree.

Data access adapter 32 encrypts EHR 120 using record key 114 to generate an encrypted EHR 80 as indicated by an arrow 144. Data access adapter 32 provides encrypted EHR 80 to encrypted data store 24 through data access front 22 as indicated by an arrow 145. Encrypted data store 24 provides a status to data access adapter 32 through data access front 22 as indicated by an arrow 147. If the status indicates that encrypted EHR 80 was not stored successfully, then data access adapter 32 may retry the store.

Once the store is successful, data access adapter 32 generates and encrypts leaf node 58 using node key 112 as indicated by an arrow 147. Data access adapter 32 generates leaf node 58 to include a reference 60 to the successfully stored encrypted EHR 80 in encrypted data store 24 and encrypts reference 60 as part of encrypting leaf node 58. Data access adapter 32 updates metadata tree 50 to include leaf node 58, a node key lockbox 62 with the node key, and a record key lockbox 64 with the record key as indicated by an arrow 148. Data access adapter 32 locks node key lockbox 62 using a node key from a parent node 56 of leaf node 58 and locks record key lockbox 64 using a record key from the parent node 56 of leaf node 58. Data access adapter 32 provides the updated metadata tree 50 to metadata store 26 through data access front 22 as indicated by an arrow 149. Metadata store 26 provides a status to data access adapter 32 through data access front 22 as indicated by an arrow 150. If the status indicates that the updated metadata tree 50 was not stored successfully, then data access adapter 32 may retry the update until it is successful.

Data access adapter 32 repeats the process shown in FIG. 5 for each EHR that is stored in encrypted data store 24.

Once an encrypted EHR 80 is stored in encrypted data store 24, a participant who generates or obtains the corresponding node and record keys may access the encrypted EHR 80 from encrypted data store 24 as shown in FIG. 6. Referring to FIGS. 4 and 6, data access adapter 32 accesses metadata tree 50 of a patient from metadata store 26 through data access front 22 as indicated by an arrow 151. Metadata store 26 provides metadata tree 50 to provider system 30 through data access front 22 as indicated by an arrow 152. Data access adapter 32 determines a leaf node 58 in metadata tree 50 corresponding to the encrypted EHR 80 as indicated by an arrow 153.

Data access adapter 32 accesses a node key 112 and a record key 114 from node key lockbox 62 and record key lockbox 64 corresponding leaf node 58 as indicated by an arrow 154. If data access adapter 32 manages the subtree that includes leaf node 58, then data access adapter 32 uses the subtree node key to successively access node keys from any intermediate nodes 56 and leaf node 58 by unlocking each successive node key lockbox 62 until the node key 112 for leaf node 58 is accessed. If data access adapter 32 does not manage the subtree that includes leaf node 58, then data access adapter 32 receives either node key 112 or a node key from an intermediate node 56 in the subtree from another participant system 30 that manages the subtree. If needed, data access adapter 32 uses the received node key to successively access node keys from any intermediate nodes 56 and leaf node 58 by unlocking each successive node key lockbox 62 until the node key 112 for leaf node 58 is accessed.

Similarly, if data access adapter 32 manages the subtree that includes leaf node 58, then data access adapter 32 uses the subtree record key to successively access record keys from any intermediate nodes 56 and leaf node 58 by unlocking each successive record key lockbox 64 until the record key 114 for leaf node 58 is accessed. If data access adapter 32 does not manage the subtree that includes leaf node 58, then data access adapter 32 receives either record key 114 or a record key from an intermediate node 56 in the subtree from another participant system 30 that manages the subtree. If needed, data access adapter 32 uses the received record key to successively access record keys from any intermediate nodes 56 and leaf node 58 by unlocking each successive record key lockbox 64 until the record key 114 for leaf node 58 is accessed.

After accessing node key 112, data access adapter 32 decrypts leaf node 58 with node key 112 to obtain reference 60 to the desired encrypted EHR 80 as indicated by an arrow 155. Data access adapter 32 accesses the encrypted EHR 80 from encrypted data store 24 through data access front 22 as indicated by an arrow 156. Encrypted data store 24 provides the desired encrypted EHR 80 through data access front 22 as indicated by an arrow 157. Data access adapter 32 decrypts encrypted EHR 80 into a decrypted EHR 120 using record key 114 as indicated by an arrow 158. Data access adapter 32 outputs the decrypted EHR 120 to the participant (e.g., by displaying the decrypted EHR 120) as indicated by an arrow 159.

Data access adapter 32 repeats the process shown in FIG. 6 for each encrypted EHR accessed from encrypted data store 24.

Because the node and record keys for each subtree are derived from the patient key of the patient in the above examples, a patient can generate subtree node and record keys for each subtree node 54 and use the subtree node and record keys to unlock the node and record key lockboxes 62 add 64 at all levels of each subtree to obtain access to all of the patient's EHRs.

A participant, including the patient, may revoke the access of another participant to EHRs stored after a revocation using the method of FIG. 7. Referring to FIGS. 4 and 7, data access adapter 32 accesses metadata tree 50 of a patient from metadata store 26 through data access front 22 as indicated by an arrow 161. Metadata store 26 provides metadata tree 50 to provider system 30 through data access front 22 as indicated by an arrow 162. Data access adapter 32 determines a node 56 in metadata tree 50 for a key revocation as indicated by an arrow 163. Data access adapter 32 revokes a node key of the node 56 by adding another node key lockbox 62 that stores a new node key to the node 56 as indicated by an arrow 164. Data access adapter 32 generates the new node key using a predefined key rotation algorithm that rotates a node key forward to select the new node key when a node key is revoked.

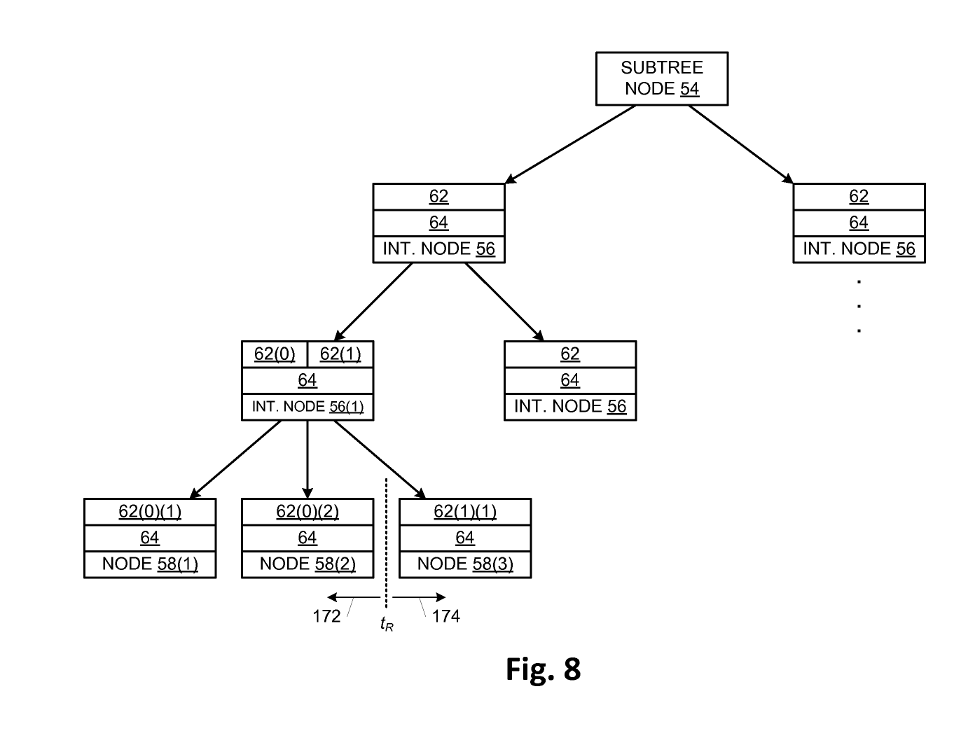

In an example key rotation shown in FIG. 8, data access adapter 32 determines a node 56(1) for a key revocation. Data access adapter 32 revokes the node key stored in node key lockbox 62(0) of node 56(1) at a time t_{R} by adding another node key lockbox 62(1) that stores a new node key to node 56(1). After the revocation, the revoked node key retains the ability to unlock node key lockboxes 62 that were stored prior to the revocation. Thus, the revoked node key in node key lockbox 62(0) may be used to unlock node key lockboxes 62(0)(1) and 62(0)(2) of leaf nodes 58(1) and 58(2), respectively, that were stored prior to time t_{R} as indicated by an arrow 172.

Node key lockboxes 62 added under a node 56 are locked using the most recently added node key for the node 56. For a node 58(3) stored after the key revocation for node 56(1) as indicated by an arrow 174, a node key lockbox 62(1)(1) is locked using the node key stored in node key lockbox 62(1) of node 56(1)—i.e., the node key added by the key revocation. The revoked node key in node key lockbox 62(0) is not usable to unlock node key lockbox 62(1)(1) or other node key lockboxes 62 that were stored subsequent to the revocation. Accordingly, the revoked node key does not provide access to the node key stored in node key lockbox 62(1)(1) to allow the reference 60 of node 58(3) to be decrypted.

A node key added as part of a key revocation for a node 56 is usable to unlock all node key lockboxes 62 added under the node 56 after the key revocation. Thus, the node key from node key lockbox 62(1) is usable to unlock node key lockbox 62(1)(1) in node 58(3) to access the node key that allows the reference 60 of node 58(3) to be decrypted. For node key lockboxes 62 added under the node 56 prior the key revocation, the new node key is rotated backwards to obtain the revoked node key. Thus, the node key from node key lockbox 62(1) is rotated backwards to obtain the revoked node key, which is also stored in node key lockbox 62(0), that unlocks node key lockboxes 62(0)(1) and 62(0)(2) for nodes 58(1) and 58(2).

Node keys from all nodes 54 and 56 above a revoked node 56 where a key revocation occurred remain usable to unlock all node key lockboxes 62 at and below the revoked node 56. Thus, key revocation does not affect access for node keys above a revoked node 56.

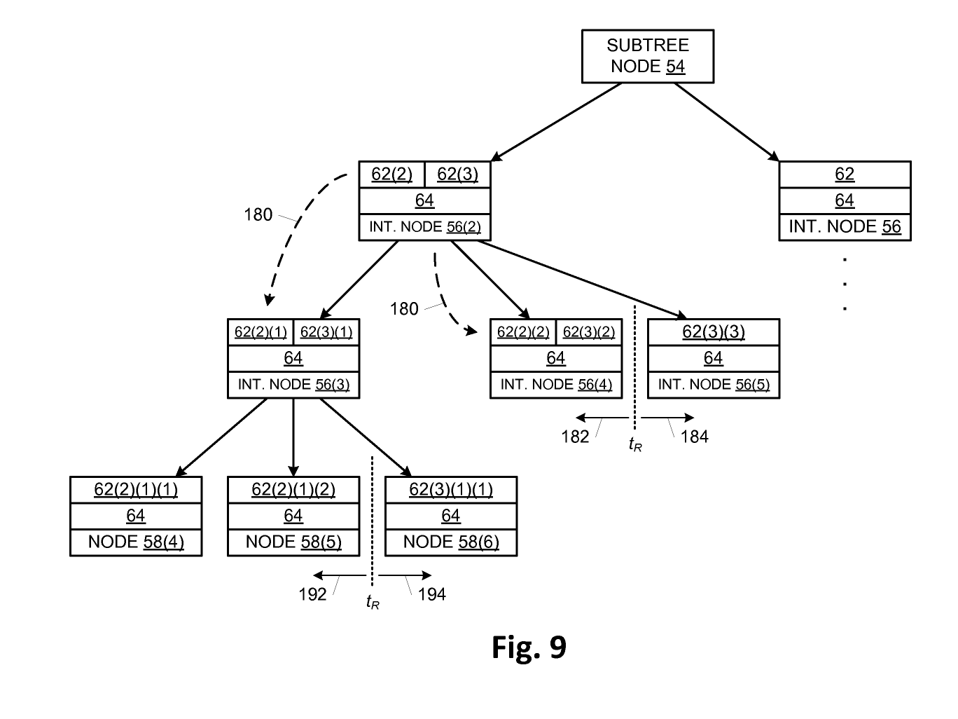

Referring back to FIG. 7, a revoked node 56 has any intermediate nodes 56 below the revoked node 56 in metadata tree 50, then data access adapter 32 propagates the key revocation to any intermediate nodes 56 below the revoked node 56 in metadata tree 50 as indicated by an arrow 165. To do so, data access adapter 32 adds another node key lockbox 62 that stores a new node key to each intermediate node 56 below the revoked node 56 as shown in the example of FIG. 9.

In FIG. 9, data access adapter 32 determines a node 56(2) for a key revocation. Data access adapter 32 revokes the node key stored in node key lockbox 62(2) of node 56(2) at a time t_{R} by adding another node key lockbox 62(3) that stores a new node key to node 56(2). Data access adapter 32 also propagates the key revocation to intermediate nodes 56(3) and 56(4), as indicated by arrows 180, by adding node key lockboxes 62(3)(1) and 62(3)(2) that store respective new node keys to intermediate node 56(3) and 56(4), respectively.

The revoked node key in node key lockbox 62(2) retains the ability to unlock node key lockboxes 62(2)(1) and 62(2)(2) of nodes 56(3) and 56(4), respectively, that were stored prior to time t_{R} as indicated by arrows 182 and 192. Similarly, the node key of node key lockbox 62(2)(1) retains the ability to unlock node key lockboxes 62(2)(1)(1) and 62(2)(1)(2) of nodes 58(4) and 58(5).

Node key lockbox 62(3)(3) of a node 56(5) stored after the key revocation for node 56(2), as indicated by an arrow 184, is locked using the node key stored in node key lockbox 62(3) of node 56(2). Similarly, node key lockbox 62(3)(1)(1) of a node 58(6) stored after the key revocation for node 56(2) and propagation to node 56(3), as indicated by an arrow 194, is locked using the node key stored in node key lockbox 62(3)(1) of node 56(3). The revoked node key in node key lockbox 62(2) is not usable to unlock node key lockboxes 62(3)(1) or 62(3)(3).

The propagated node key from node key lockbox 62(3)(1) is usable to unlock node key lockbox 63(3)(1)(1) in node 58(6) to access the node key that allows the reference 60 of node 58(6) to be decrypted. The node key from node key lockbox 62(3)(1) is rotated backwards to obtain the node key stored in node key lockbox 62(2)(1) that unlocks node key lockboxes 62(2)(1)(1) and 62(2)(1)(2) for nodes 58(4) and 58(5).

With the key revocation method of FIG. 7, record keys in record key lockboxes 64 remain unchanged as a result of any key revocations of node keys. The revocation of node keys is sufficient to prevent access to EHRs stored after a revocation because the use of the new node keys prevents a participant who does not have the new node keys (e.g., a participant who only has the revoked node keys) from accessing references 60 to EHRs stored after a revocation.

Participant systems 30 that manage subtrees of metadata tree 50 use node and record seeds generated from the subtree node and subtree record keys, respectively, of the corresponding subtree nodes 54 to perform the above key rotations. The node seed for a node key lockbox 62 of a node 51 may be computed as a hash of the node identifier 91 (shown in FIG. 3) and the subtree node key. The record seed for a record key lockbox 64 of a node 51 may be computed as a hash of the node identifier 91 (shown in FIG. 3) and the subtree record key.

The above embodiments may advantageously allow healthcare participants to securely manage and share EHRs in a common encrypted data store using a metadata tree with hierarchical lockboxes. Healthcare participants control the ability of others healthcare participants to access and store selected EHRs of a patient using node and record keys for each node in the metadata tree. By providing subtree keys derived from a patient key to selected healthcare providers, a patient maintains the ability to access all of the EHRs of the patient using the patient key. Healthcare participants, including the patient, also retain the ability to selectively revoke access of other healthcare participants using key revocation at any level of the metadata tree.

What is claimed is:

1. A method performed by a first processing system, the method comprising:
encrypting an electronic health record of a patient using a first record key to generate an encrypted record;
encrypting at least a portion of a first node of a metadata tree of the patient with a first node key to generate a first encrypted node, the portion including a reference to the encrypted record in an encrypted data store; and
updating the metadata tree for the patient to include the first encrypted node and a first node key lockbox with the first node key.

2. The method of claim 1 wherein the first encrypted node is under a second encrypted node in the metadata tree, and wherein the first node key lockbox is unlockable with a second node key from a second node key lockbox corresponding to the second encrypted node.

3. The method of claim 1 further comprising:
updating the metadata tree for the patient to include a first record key lockbox with the first record key.

4. The method of claim 3 wherein the first encrypted node is under a second encrypted node in the metadata tree, and wherein the first record key lockbox is unlockable with a second record key that is stored in a second record key lockbox corresponding to the second encrypted node.

5. The method of claim 1 further comprising:
providing the first encrypted record to the encrypted data store; and
providing the encrypted node, the first node key lockbox, and the first record key lockbox to a metadata store that stores the metadata tree.

6. The method of claim 1 wherein a subtree in the metadata tree includes the first encrypted node and an encrypted subtree node that is encrypted with a subtree node key generated from a patient key of the patient.

7. The method of claim 1 further comprising:
generating the first node key and the first record key from a subtree node key and a subtree record key, respectively.

8. The method of claim 1 further comprising:
receiving the first node key and the first record key from a second processing system that manages a subtree in the metadata tree includes the first encrypted node.

9. A processing system comprising:
a set of one or more processors; and
a memory storing a set of instructions that, when executed by the set of processors, cause the set of processors to:
access a first node key that corresponds to a first encrypted node of a metadata tree of a patient from a first node key lockbox by unlocking the first node key lockbox with a second node key that corresponds to a second encrypted node of the metadata tree; and
decrypt the first encrypted node with the first node key to obtain a reference to an encrypted electronic health record in an encrypted data store.

10. The processing system of claim 9 wherein the set of instructions, when executed by the set of processors, cause the set of processors to:
prior to accessing the first node key, access the second node key from a second node key lockbox corresponding to the second encrypted node by unlocking the second node key lockbox with a third node key that corresponds to a third encrypted node of the metadata tree.

11. The processing system of claim 9 wherein the set of instructions, when executed by the set of processors, cause the set of processors to:
access a first record key that corresponds to the first encrypted node from a first record key lockbox by unlocking the first record key lockbox with a second record key that corresponds to the second encrypted node;
access the encrypted electronic health record from the encrypted data store; and
decrypt the encrypted electronic health record using the first record key.

12. The processing system of claim 11 wherein the set of instructions, when executed by the set of processors, cause the set of processors to:
prior to accessing the first record key, access the second record key from a second record key lockbox corresponding to the second encrypted node by unlocking the second record key lockbox with a third record key that corresponds to a third encrypted node of the metadata tree.

13. The processing system of claim 9 wherein a subtree in the metadata tree includes the first encrypted node and an encrypted subtree node that is encrypted with a subtree node key generated from a patient key of the patient.

14. An article comprising at least one machine-readable storage medium storing instructions that, when executed by a processing system, cause the processing system to:
determine a first node in a metadata tree of a patient for a key revocation, the first node corresponding to a first node key lockbox that stores a first node key; and
revoke the first node key by adding a second node key lockbox that stores a second node key to the first node.

15. The article of claim 13, wherein the first node key is usable to access a first set of nodes under the first encrypted node that is stored prior to the first node key being revoked but is not usable to access a second set of encrypted nodes under the first node that is stored subsequent to the first node key being revoked, and wherein the second node key is usable to access the second set of nodes.

16. The article of claim 15, wherein the instructions, when executed by the processing system, cause the processing system to:
add a third node key lockbox for a first one of the first set of nodes that stores a third node key; and
lock the third node key lockbox using the second node key.
